(19) United States
(12) Patent Application Publication
(10) Pub. No.: US 2014/0320762 A1
(43) Pub. Date: Oct. 30, 2014

(54) DISPLAY DEVICE AND METHOD OF MANUFACTURING THE SAME

(71) Applicant: SAMSUNG DISPLAY CO., LTD., Yongin-City (KR)

(72) Inventors: Chang-Yong JEONG, Yongin-City (KR); Mu-Gyeom KIM, Yongin-City (KR); Myung-Suk HAN, Yongin-City (KR)

(73) Assignee: SAMSUNG DISPLAY CO., LTD., Yongin-City (KR)

(21) Appl. No.: 14/249,715

(22) Filed: Apr. 10, 2014

(30) Foreign Application Priority Data
Apr. 29, 2013 (KR) 10-2013-0047508

(51) Int. Cl. G06F 3/041; G06F 1/16

(52) U.S. Cl. CPC G06F 3/041; G06F 1/16
USPC 349/12; 445/24

(57) ABSTRACT

A display device includes a display panel having a display region and a peripheral region bent toward a back side of the display region, the display panel being movable along a direction in which an external force is applied, a touch panel on the display region of the display panel, a receiving container having a bottom and a side wall perpendicular to the bottom, the receiving container being configured to receive the display panel, at least two first buffer member on the bottom of the receiving container and spaced apart from each other, the first buffer members contacting the peripheral region of the display panel, and at least one second buffer member on the side wall of the receiving container.

### CROSS-REFERENCE TO RELATED APPLICATION

Korean Patent Application No. 10-2013-0047508 filed on Apr. 29, 2013, in the Korean Intellectual Property Office, and entitled: “DISPLAY DEVICE AND METHOD OF MANUFACTURING THE SAME,” is incorporated by reference herein in its entirety.

### BACKGROUND

1. Field

Example embodiments relate generally to a technique for manufacturing a display device. More particularly, example embodiments relate to a display device, and a method of manufacturing the display device.

2. Description of the Related Art

A display device is widely used because it has low power consumption, small thickness, small size, etc. The display device may generally include a display panel, a receiving container, a touch panel, etc. A display device having a display panel and a touch panel has recently been developed, as the display device is getting smaller.

### SUMMARY

According to some example embodiments, a display device may include a display panel having a display region and a peripheral region bent toward a back side of the display region, the display panel being movable along a direction in which an external force is applied, a touch panel on the display region of the display panel, a receiving container having a bottom and a side wall perpendicular to the bottom, the receiving container being configured to receive the display panel, at least two first buffer member on the bottom of the receiving container and spaced apart from each other, the first buffer members contacting the peripheral region of the display panel, and at least one second buffer member on the side wall of the receiving container.

In example embodiments, a display device may further include a supporting member disposed in the receiving container, the supporting member supporting the display panel and at least one third buffer member interposed between the bottom of the receiving container and the supporting member.

In example embodiments, the display panel may include a substrate, a display structure disposed on the substrate and a thin encapsulating member disposed on the substrate to encapsulate the display structure.

In example embodiments, the touch panel may include a polarizing layer disposed on the thin encapsulating member, a touch screen panel disposed on the polarizing layer, a window disposed on the touch screen panel, a first adhesive member interposed between the polarizing layer and the touch screen panel, and a second adhesive member interposed between touch screen panel and the window.

In example embodiments, the peripheral region of the display panel may be additionally bent to the back side of the display region corresponding to the external force applied to the touch panel.

In example embodiments, the first buffer member, the second buffer member and the third buffer member may include substantially the same materials or different materials.

According to some example embodiments, a display device may include a display panel having a display region and a peripheral region bent to a back side of the display region, the display panel being moved along a direction in which an external force is applied, a touch panel disposed on the display region of the display panel, a receiving container having a bottom and a side wall extended substantially perpendicular from the bottom, the receiving container receiving the display panel, a fourth buffer member disposed on at least one of a first face of the display panel and a second face of the display panel, and at least one fifth buffer member disposed on the side wall of the receiving container.

In example embodiments, a display device may further include an adhesive member disposed in the receiving container, the adhesive member attaching the receiving container and the display panel to each other.

In example embodiments, the display panel may include a substrate, a display structure disposed on the substrate and a thin encapsulating member disposed on the substrate to encapsulate the display structure.

In example embodiments, the touch panel may include a polarizing layer disposed on the thin encapsulating member, a touch screen panel disposed on the polarizing layer, a window disposed on the touch screen panel, a first adhesive member interposed between the polarizing layer and the touch screen panel, and a second adhesive member interposed between touch screen panel and the window.

In example embodiments, the fourth buffer member may include a cushion layer that is formed having fluidity, and the display panel and the touch panel may be moved along a direction in which an external force is applied by using the fluidity of the cushion layer.

In example embodiments, the fourth buffer member may include a coating layer that is formed having fluidity, and the display panel and the touch panel may be moved along a direction in which an external force is applied by using the fluidity of the coating layer.

In example embodiments, the first buffer member, the second buffer member and the third buffer member may include substantially the same materials or different materials.

In example embodiments, the receiving container and the adhesive member may have a porous structure.

In example embodiments, the display panel may be received in the receiving container and may be spaced apart from the bottom of the receiving container and the side wall of the receiving container.

According to some example embodiments, a method of manufacturing a display device may include a step of providing a receiving container having a bottom and a side wall extended substantially perpendicular from the bottom, forming a first buffer member on the bottom of the receiving container, forming a second buffer member on the side wall of the receiving container, receiving a display panel being moved along a direction in which an external force is applied in a receiving container, and forming a touch panel on the display panel.

In example embodiments, the peripheral region of the display panel may be additionally bent to the back side of the display region corresponding to an external force applied to the touch panel.

According to some example embodiments, a method of manufacturing a display device may include a step of providing a receiving container having a bottom and a side wall extended substantially perpendicular from the bottom, forming a fourth buffer member on at least one of a first face of the display panel and a second face opposing the first face of the display panel, forming a fifth buffer member on the side wall of the receiving container, receiving a display panel in a receiving container, the display panel being moved along a direction in which an external force is applied, and forming a touch panel on the display panel.

In example embodiments, the fourth buffer member and the fifth buffer member may be formed by a slit coating process, a bar coating process, or a spin coating process, and the fourth buffer member and the fifth buffer member may include substantially the same materials or different materials.

In example embodiments, the fourth buffer member may include a cushion layer formed having fluidity and a coating layer formed having fluidity.

### BRIEF DESCRIPTION OF THE DRAWINGS

Illustrative, non-limiting example embodiments will be more clearly understood from the following detailed description taken in conjunction with the accompanying drawings, in which:

FIG. 1 is a cross-sectional view illustrating a display device in accordance with example embodiments.

FIG. 2 is a cross-sectional view illustrating a display panel included in the display device of FIG. 1.

FIG. 3 is a diagram illustrating an example in which an external force is applied to the display device of FIG. 1.

FIGS. 4 through 6 are diagrams illustrating stages in a method of manufacturing a display device in accordance with example embodiments.

FIG. 7 is a cross-sectional view illustrating a display device in accordance with example embodiments.

FIG. 8 is a diagram illustrating an example in which an external force is applied to the display device of FIG. 7.

FIGS. 9 through 12 are diagrams illustrating stages in a method of manufacturing a display device in accordance with example embodiments.

FIG. 13 is a cross-sectional view illustrating a display device in accordance with example embodiments.

FIG. 14 is a diagram illustrating an example in which an external force is applied to a display device of FIG. 13.

### DETAILED DESCRIPTION

Various example embodiments will be described more fully hereinafter with reference to the accompanying drawings, in which some example embodiments are shown. Example embodiments may, however, be embodied in many different forms and should not be construed as limited to those set forth herein. Rather, these example embodiments are provided so this disclosure will be thorough and complete, and will fully convey the scope of the exemplary implementations to those skilled in the art. In the drawings, the sizes and relative sizes of layers and regions may be exaggerated for clarity. Like reference numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting thereof. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

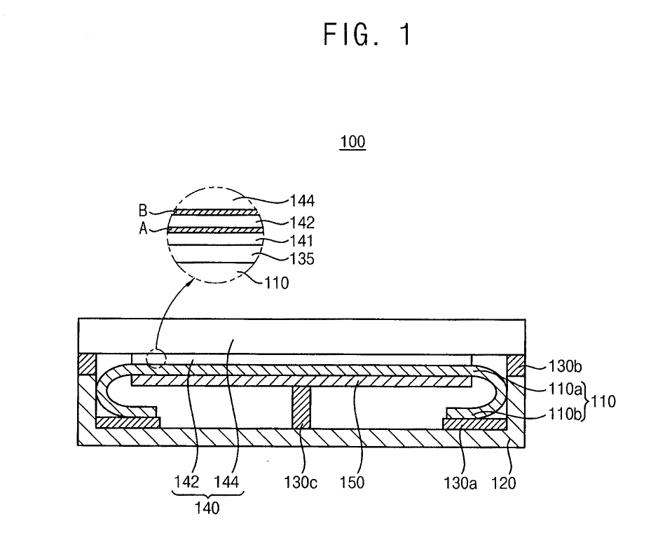

FIG. 1 is a cross-sectional view illustrating a display device in accordance with example embodiments.

Referring to FIG. 1, a display device 100 may include a display panel 110, a receiving container 120, first through third buffer members 130a, 130b, and 130c, a touch panel 140, a supporting member 150, etc.

The display panel 110 may include a display region 110a and a peripheral region 110b bent toward a back side of the display region 110a. The display panel 110 may further include a substrate, a display structure disposed on the substrate, and a thin encapsulating member that encapsulates the display structure.

In example embodiments, the display panel 110 may be movable along a direction in which an external force is applied. For example, the display panel 110 may be subject to an external force, e.g., pressure resultant from a touch by a user, from the touch panel 140 when the user touches or presses the touch panel 140. In this case, the display panel 110 may bend, e.g., be pushed, in correspondence with the external force toward a bottom of the receiving container 120, thereby buffering the external force. Accordingly, the display panel 110 may prevent damage to the display panel 140 due to the external force. An external force-buffer function of the display panel 110 will be described below in detail.

In example embodiments, the display panel 110 may correspond to a display panel of an organic light emitting diode (OLED) display device. However, embodiments are not limited thereto. For example, the display panel 110 may correspond to a display panel of a liquid crystal display (LCD) device.

The receiving container 120 may include a bottom and a side wall extending substantially perpendicularly from the bottom. In example embodiments, the receiving container 120 may receive the display panel 110. For example, the receiving container 120 may include metal, e.g., aluminum (Al), stainless steel, etc. In example embodiments, the display panel 110 may be spaced apart from the bottom of the receiving container 120 and from the side wall of the receiving container 120.

For example, the receiving container 120 may correspond to a bezel, in which the display panel 110 is received. In another example, the receiving container 120 may correspond to a mold frame, e.g., the mold frame may be combined with the bezel to fix the display panel 110.

The supporting member 150 may be disposed in the receiving container 120. In this case, the supporting member 150 may support the display panel 110 received in the receiving container 120. For example, the supporting member 150 may include a metal. However, embodiments are not limited thereto, e.g., the supporting member 150 may include prescribed materials having a predetermined strength.

The first buffer member 130a may be on, e.g., directly on, the bottom of the receiving container 120, e.g., a plurality of the first buffer member 130a may be spaced apart from each other on the bottom of the receiving container 120. The first buffer member 130a may contact the peripheral region 110b of the display panel 110, e.g., the first buffer member 130a may contact a bent peripheral region of the display panel 110. In example embodiments, an adhesive tape (not illustrated) may be interposed between the first buffer member 130a and the display panel 110, and thus the adhesive tape may attach the first buffer member 130a and the display panel 110 to each other.

The second buffer member 130b may be disposed on a side wall of the receiving container 120. The third buffer member 130c may be interposed between the bottom of the receiving container 120 and the supporting member 150. In this case, the first through the third buffer members 130a, 130b, and 130c may include a material having elasticity, e.g., silicon, a rubber, a urethane, etc. In example embodiments, the first through third buffer members 130a, 130b, and 130c may include substantially the same materials. However, embodiments are not limited thereto, e.g., the first through third buffer members 130a, 130b, and 130c may include different materials.

The touch panel 140 may be disposed on the display region of the display panel 110. In example embodiments, the touch panel 140 may include a polarizing layer 141 disposed on a thin encapsulating member (135), a touch screen panel 142 disposed on the polarizing layer 141, a window 144 disposed on the touch screen panel 142, a first adhesive member A interposed between the polarizing layer 141 and the touch screen panel 142, and a second adhesive member B interposed between the touch screen panel 142 and the window 144. For example, the first adhesive member A and the second adhesive member B may include a resin.

The display device 100 according to example embodiments may include a thin encapsulating member and a structure in which the display panel 110 and the touch panel 140 are integrated, and thus the display device 100 may have a small thickness. Further, as a conventional display device may not easily control a foreign substance between the display panel 110 and the receiving container 120, e.g., a user's touch may press the touch panel 140 and cause adjacent liquid crystal molecules to continuously splash along the pressurized portion (i.e., referred to as a pooling effect), the display device 100 according to example embodiments may include the display panel 110, which is additionally bent in correspondence with the external force, thereby being capable of buffering the external force. Hence, the display device 100 may have a small thickness and an improved image quality.

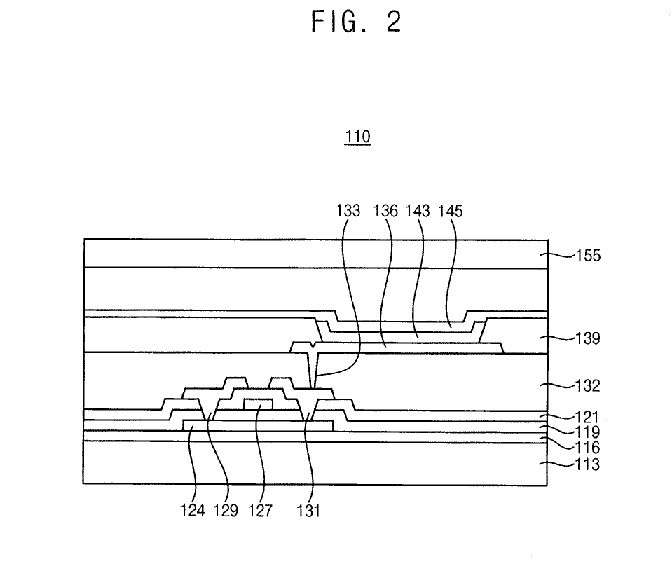

FIG. 2 is a cross-sectional view illustrating the display panel 110. Referring to FIG. 2, the display panel 110 may include a first substrate 113, a switching device, a first electrode 136, a light emitting structure 143, a second electrode 145, a second substrate 155, etc.

A buffer layer 116 may be disposed on the first substrate 113. The first substrate 113 may include a transparent insulation substrate. For example, the first substrate 113 may include a glass substrate, a quartz substrate, a transparent resin substrate, etc. Examples of the transparent resin substrate for the first substrate 113 may include polyimide-based resin, acryl-based resin, polyacrylate-based resin, polycarbonate-based resin, polyether-based resin, sulfonic acid-containing resin, polyethyleneterephthalate-based resin, etc.

In example embodiments, the buffer layer 116 may prevent diffusion of metal atoms and/or impurities from the first substrate 113. Additionally, the buffer layer 116 may adjust heat transfer rate of a subsequent crystallization process for an active pattern 124, thereby obtaining a substantially uniform active pattern 124. In case that the first substrate 113 has a relatively irregular surface, the buffer layer 116 may improve flatness of the surface of the first substrate 113. The buffer layer 116 may be formed using a silicon compound. For example, the buffer layer 116 may include silicon oxide (SiOₓ), silicon nitride (SiNₓ), silicon oxynitride (SiOₓN_{y}), silicon oxycarbide (SiOₓC_{y}), silicon carbon nitride (SiCₓN_{y}), etc. These may be used alone or in a mixture thereof. The buffer layer 116 may have a single layer structure or a multi layer structure. For example, the buffer layer 116 may have a single layer structure including a silicon oxide film, a silicon nitride film, a silicon oxynitride film, a silicon oxycarbide film, or a silicon carbon nitride film. In another example, the buffer layer 116 may have a multi layer structure including at least two of a silicon oxide film, a silicon nitride film, a silicon oxynitride film, a silicon oxycarbide film, a silicon carbon nitride film, etc.

The switching device may be provided on the buffer layer 116. In example embodiments, the switching device may include a thin film transistor (TFT) having the active pattern 124 that may contain silicon (Si). For example, the switching device may include the active pattern 124, a gate insulation layer 119, a gate electrode 127, a source electrode 129, a drain electrode 131, etc. In another example, the switching device may include an oxide semiconductor device having an active pattern that may contain semiconductor oxides.

When the switching device includes the TFT, the active pattern 124 may be disposed on the buffer layer 116. The active pattern 124 may have a source region and a drain region both of which are doped with impurities. The active pattern 124 may additionally include a channel region provided between the source region and the drain region.

In example embodiments, a semiconductor layer (not illustrated) may be formed on the buffer layer 116, and then a preliminary active layer (not illustrated) may be formed on the buffer layer 116 by patterning the semiconductor layer. The crystallization process may be executed on the preliminary active layer to form the active pattern 124 on the buffer layer 116. When the semiconductor layer includes amorphous silicon, the active pattern 124 may include polysilicon. The crystallization process for forming the active pattern 124 may include a laser irradiation process, a thermal treatment process, a thermal process utilizing a catalyst, etc.

The gate insulation layer 119 may be disposed on the buffer layer 116 to cover the active pattern 124. The gate insulation layer 119 may include silicon oxide, metal oxide, etc. Examples of metal oxide in the gate insulation layer 119 may include hafnium oxide (HfOₓ), aluminum oxide (AlOₓ), zirconium oxide (ZrOₓ), titanium oxide (TiOₓ), tantalum oxide (TaOₓ), etc. These may be used alone or in a combination thereof. In example embodiments, the gate insulation layer 119 may be uniformly formed on the buffer layer 116 along a profile of the active pattern 124. For example, the gate insulation layer 119 may have a substantially small thickness, such that a stepped portion may be generated at a portion of the gate insulation layer 119 adjacent to the active pattern 124. Alternatively, the gate insulation layer 119 may have a relatively large thickness for sufficiently covering the active pattern 124, and thus the gate insulation layer 119 may have a substantially level surface.

The gate electrode 127 may be located on the gate insulation layer 119. For example, the gate electrode 127 may be positioned on a portion of the gate insulation layer 119 under which the active pattern 124 is located. In example embodiments, a first conductive layer (not illustrated) may be formed on the gate insulation layer 119, and then the first conductive layer may be partially etched by a photolithography process or an etching process using an additional etching mask. Hence, the gate electrode 127 may be provided on the gate insulation layer 119. The gate electrode 127 may include a metal, an alloy, a conductive metal oxide, a transparent conductive material, etc. For example, the gate electrode 127 may be formed using aluminum (Al), an alloy containing aluminum, aluminum nitride (AlNₓ), silver (Ag), an alloy containing silver, tungsten (W), tungsten nitride (WNₓ), copper (Cu), an alloy containing copper, nickel (Ni), an alloy containing nickel, chromium (Cr), chromium nitride (CrNₓ), molybdenum (Mo), an alloy containing molybdenum, titanium (Ti), titanium nitride (TiNₓ), platinum (Pt), tantalum (Ta), tantalum nitride (TaNₓ), neodymium (Nd), scandium (Sc), strontium ruthenium oxide (SRO), zinc oxide (ZnOₓ), indium tin oxide (ITO), tin oxide (SnOₓ), indium oxide (InOₓ), gallium oxide (GaOₓ), indium zinc oxide (IZO), etc. These may be used alone or in a combination thereof. In example embodiments, the gate electrode 127 may have a single layer structure or a multi layer structure, which may include a metal film, an alloy film, a metal nitride film, a conductive metal oxide film, and/or a transparent conductive film.

An insulating interlayer 121 may be disposed on the gate insulation layer 119 to cover the gate electrode 127. The insulating interlayer 121 may electrically insulate the source and the drain electrodes 129 and 131 from the gate electrode 127. The insulating interlayer 121 having a substantially uniform thickness may be conformally formed on the gate insulation layer 119 along a profile of the gate electrode 127. Thus, a stepped portion may be generated at a portion of the insulating interlayer 121 adjacent to the gate electrode 127. The insulating interlayer 121 may be formed using a silicon compound. For example, the insulating interlayer 121 may include silicon oxide, silicon nitride, silicon oxynitride, silicon oxycarbide, and/or silicon carbon nitride. These may be used alone or in a mixture thereof. In example embodiments, the insulating interlayer 121 may have a single layer structure or a multi layer structure, which may include a silicon oxide film, a silicon nitride film, a silicon oxynitride film, a silicon oxycarbide film, and/or a silicon carbon nitride film.

As illustrated in FIG. 2, the source electrode 129 and the drain electrode 131 may be disposed on the insulating interlayer 121. The source and the drain electrodes 129 and 131 may be separated from each other by a predetermined distance substantially centering the gate electrode 127. The source and the drain electrodes 129 and 131 may pass through the insulating interlayer 121, and may make contact with the source and the drain regions of the active pattern 124, respectively.

In example embodiments, the insulating interlayer 121 may be partially etched to form contact holes exposing the source and the drain regions, respectively. Then, a second conductive layer (not illustrated) may be formed on the insulating interlayer 121 to fill the contact holes. The second conductive layer may be removed until the insulating interlayer 121 is exposed, and thus the source and the drain electrodes 129 and 131 may be formed on the source and the drain regions, respectively. Each of the source and the drain electrodes 129 and 131 may include metal, alloy, metal nitride, conductive metal oxide, and/or a transparent conductive material, etc. For example, the source and the drain electrodes 129 and 131 may be formed using aluminum, an alloy containing aluminum, aluminum nitride, silver, an alloy containing silver, tungsten, tungsten nitride, copper, an alloy containing copper, nickel, an alloy containing nickel, chromium, chrome nitride, molybdenum, an alloy containing molybdenum, titanium, titanium nitride, platinum, tantalum, tantalum nitride, neodymium, scandium, strontium ruthenium oxide, zinc oxide, indium tin oxide, tin oxide, indium oxide, gallium oxide, and/or indium zinc oxide, etc. These may be used alone or in a combination thereof. In example embodiments, each of the source and the drain electrodes 129 and 131 may have a single layer structure or a multi layer structure, which may include a metal film, an alloy film, a metal nitride film, a conductive metal oxide film, and/or a transparent conductive film.

As formation of the source and the drain electrodes 129 and 131 on the insulating interlayer 121 is complete, the switching device may be provided on the first substrate 113. The switching device may include the TFT that may have the active pattern 124, the gate insulation layer 119, the gate electrode 127, the source electrode 129, and the drain electrode 131.

An insulation layer 132 may be disposed on the insulating interlayer 121 to cover the source and drain electrodes 129 and 131. The insulation layer 132 may have a single layer structure or a multi layer structure including at least two insulation films. In example embodiments, a planarization process may be executed on the insulation layer 132 to enhance the flatness of the insulation layer 132. For example, the insulation layer 132 may have a substantially level surface by a chemical mechanical polishing (CMP) process, an etch-back process, etc. The insulation layer 132 may be formed using an organic material. For example, the insulation layer 132 may include a photoresist, an acryl-based resin, a polyimide-based resin, a polyamide-based resin, a siloxane-based resin, etc. These may be used alone or in a combination thereof. In another example, the insulation layer 132 may include an inorganic material, e.g., silicon oxide, silicon nitride, silicon oxynitride, silicon oxycarbide, aluminum, magnesium, zinc, hafnium, zirconium, titanium, tantalum, aluminum oxide, titanium oxide, tantalum oxide, magnesium oxide, zinc oxide, hafnium oxide, zirconium oxide, titanium oxide, etc. These may be used alone or in a mixture thereof.

The insulation layer 132 may be partially etched by a photolithography process or an etching process using an additional etching mask such as a hard mask, and thus a contact hole 133 may be formed through the insulation layer 132. The contact hole 133 may partially expose the drain electrode 131 of the switching device. In example embodiments, the contact hole 133 may have a side wall inclined by a predetermined angle relative to the first substrate 113. For example, the contact hole 133 may have an upper width substantially larger than a lower width thereof.

The first electrode 136 may be disposed on the insulation layer 132 to fill the contact hole 133 formed through the insulation layer 132. Thus, the first electrode 136 may make contact with the drain electrode 131 exposed by the contact hole 133. Alternatively, a contact, a plug, or a pad may be formed in the contact hole 133, and then the first electrode 136 may be formed on the contact, the plug, or the pad. For example, the first electrode 136 may be electrically connected to the drain electrode 131 through the contact, the plug, or the pad.

The first electrode 136 may include a reflective material or a transparent material in accordance with the emission type of the display device. For example, the first electrode 136 may be formed using aluminum, an alloy containing aluminum, aluminum nitride, silver, an alloy containing silver, tungsten, tungsten nitride, copper, an alloy containing copper, nickel, an alloy containing nickel, chromium, chromium nitride, molybdenum, an alloy containing molybdenum, titanium, titanium nitride, platinum, tantalum, tantalum nitride, neodymium, scandium, strontium ruthenium oxide, zinc oxide, indium tin oxide, tin oxide, indium oxide, gallium oxide, indium zinc oxide, etc. These may be used alone or in a combination thereof. In example embodiments, the first electrode 136 may have a single layer structure or a multi layer structure, which may include a metal film, an alloy film, a metal nitride film, a conductive metal oxide film, and/or a transparent conductive film.

A pixel defining layer 136 may be disposed on the first electrode 136 and the insulation layer 132. The pixel defining layer 136 may include an organic material or an inorganic material. For example, the pixel defining layer 136 may be formed using photoresist, an acryl-based resin, a polyacryl-based resin, a polyimide-based resin, a silicon compound, etc. In example embodiments, the pixel defining layer 136 may be partially etched to form an opening partially exposing the first electrode 136. The opening of the pixel defining layer 136 may define a luminescent region and a non-luminescent region of the display device. For example, a portion having the opening of the pixel defining layer 136 may be the luminescent region of the display device while another portion around the opening of the pixel defining layer 136 may be the non-luminescent region of the display device.

The light emitting structure 143 may be positioned on the first electrode 136 exposed by the opening of the pixel defining layer 136. The light emitting structure 143 may extend on a side wall of the opening of the pixel defining layer 136. In example embodiments, the light emitting structure 143 may include an organic light emitting layer (EL), a hole injection layer (HIL), a hole transfer layer (HTL), an electron transfer layer (ETL), an electron injection layer (EIL), etc. In example embodiments, a plurality of organic light emitting layers may be formed using light emitting materials for generating different colors of light such as a red color of light (R), a green color of light (G), and a blue color of light (B) in accordance with color pixels of the display device. In another example, the organic light emitting layer of the of the light emitting structure 143 may include a plurality of stacked light emitting materials for generating a red color of light, a green color of light, and a blue color of light to thereby emitting a white color of light.

The second electrode 145 may be disposed on the pixel defining layer 136 and the light emitting structure 143. The second electrode 145 may include a transparent material or a reflective material in accordance with the emission type of the display device. For example, the second electrode 145 may be formed using aluminum, an alloy containing aluminum, aluminum nitride, silver, an alloy containing silver, tungsten, tungsten nitride, copper, an alloy containing copper, nickel, an alloy containing nickel, chromium, chromium nitride, molybdenum, an alloy containing molybdenum, titanium, titanium nitride, platinum, tantalum, tantalum nitride, neodymium, scandium, strontium ruthenium oxide, zinc oxide, indium tin oxide, tin oxide, indium oxide, gallium oxide, indium zinc oxide, etc. These may be used alone or in a combination thereof. In example embodiments, the second electrode 145 may also have a single layer structure or a multi layer structure, which may include a metal film, an alloy film, a metal nitride film, a conductive metal oxide film, and/or a transparent conductive film.

The second substrate 155 may be positioned on the second electrode 145. The second substrate 155 may include a transparent insulation substrate. For example, the second substrate 155 may include a glass substrate, a quartz substrate, a transparent resin substrate, etc. In example embodiments, a predetermined space may be provided between the second electrode 145 and the second substrate 155. This space may be filled with air or an inactive gas, e.g., nitrogen (N₂) gas. In another example, a protection layer (not illustrated) may be additionally disposed between the second electrode 145 and the second substrate 155. For example, the protection layer may include a resin, e.g., a photoresist, an acryl-based resin, a polyimide-based resin, a polyamide-based resin, a siloxane-based resin, etc.

Although the display device 100 includes the display panel 110, e.g., a display panel of an OLED display device, other configurations are not excluded, e.g., the display panel 110 may be a LCD panel.

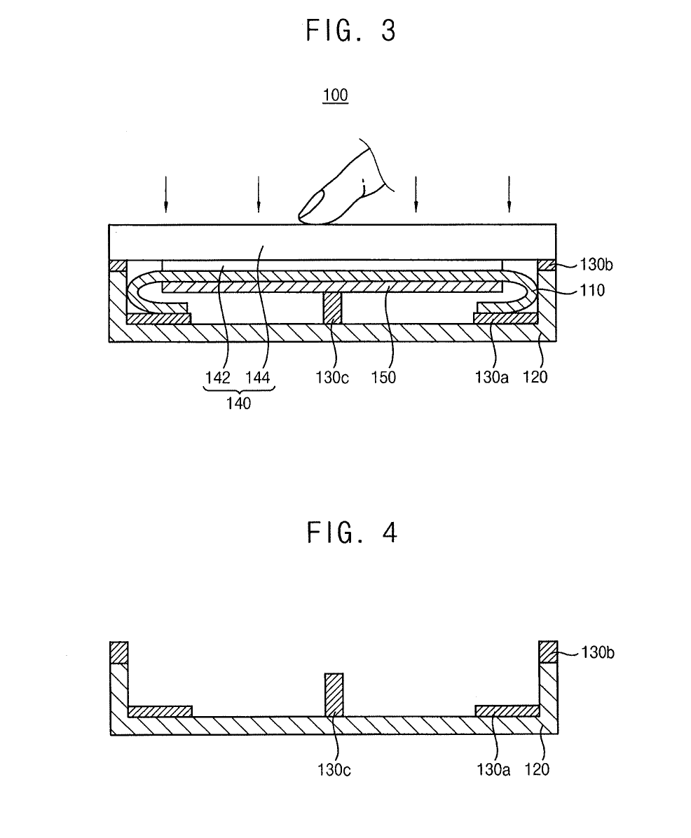

FIG. 3 is a diagram illustrating an example in which an external force is applied to a display device 100.

Referring to FIG. 3, if the touch panel 140 is applied with an external force (e.g., a touch of a user), the peripheral region of the display panel 110 may be additionally bent in correspondence with the external force. That is, as the peripheral region of the display panel 110 is bent, e.g., the peripheral region of the display panel 110 may be bent almost 180 degrees to overlap an edge of a back surface of the display region, and contacts the first buffer member 130a, a space may be defined between the display region 110a and the bent peripheral region 110b. In this case, when force is applied to the display region 110a of the display panel 110, the display region 110a may be further bent or pushed against the bent peripheral region 110b and the elastic first buffer member 130a in correspondence with the external force. As the elastic first buffer member 130a absorbs the applied force, damage to the display panel 110, e.g., a dark spot, may be prevented or substantially minimized, thereby improving image quality. Accordingly, the display device 100 may prevent a pooling effect when a foreign substance exists between the display panel 110 and the receiving container 120.

FIGS. 4 through 6 are diagrams illustrating stages in a method of manufacturing a display device in accordance with example embodiments.

Referring to FIG. 4, the receiving container 120 having the bottom and the side wall extended substantially perpendicularly from the bottom may be provided. In example embodiments, the first buffer members 130a may be disposed on the receiving container 120 and may be spaced apart from each other. The second buffer member 130b may be disposed on the side wall of the receiving container 120. The third buffer member 130c may be disposed on the bottom of the receiving container 120 between the first buffer members 130a.

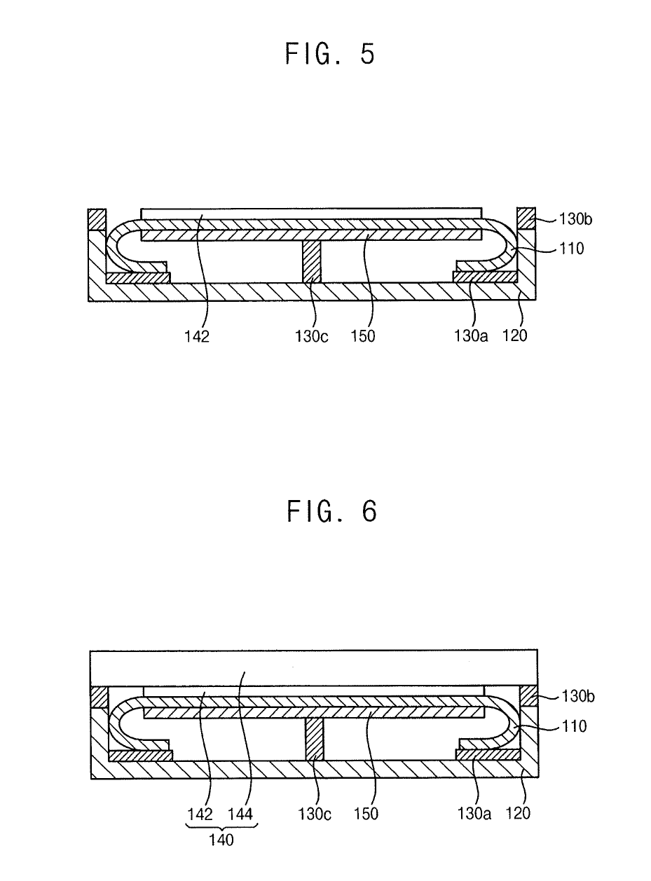

Referring to FIG. 5, the supporting member 150 that supports the display panel 110 may be disposed in the receiving container 120. Next, the display panel 110 may be received in the receiving container 120. For example, the display panel 110 may include the display region and the peripheral region bent to a back side of the display region, and may be supported by the supporting member 150. In example embodiments, the display panel 110 may be spaced apart from the bottom of the receiving container 120 and the side wall of the receiving container 120. The touch screen panel 142 may be disposed on the display panel 110.

Referring to FIG. 6, the touch panel 140 may be completed by disposing the window 144 on the touch screen panel 142.

In example embodiments, the display panel 110 may be additionally bent corresponding to an external force (e.g., a touch of a user), and thus the display device 100 may buffer the external force. Hence, the display device 100 may have a small thickness and an improved image quality.

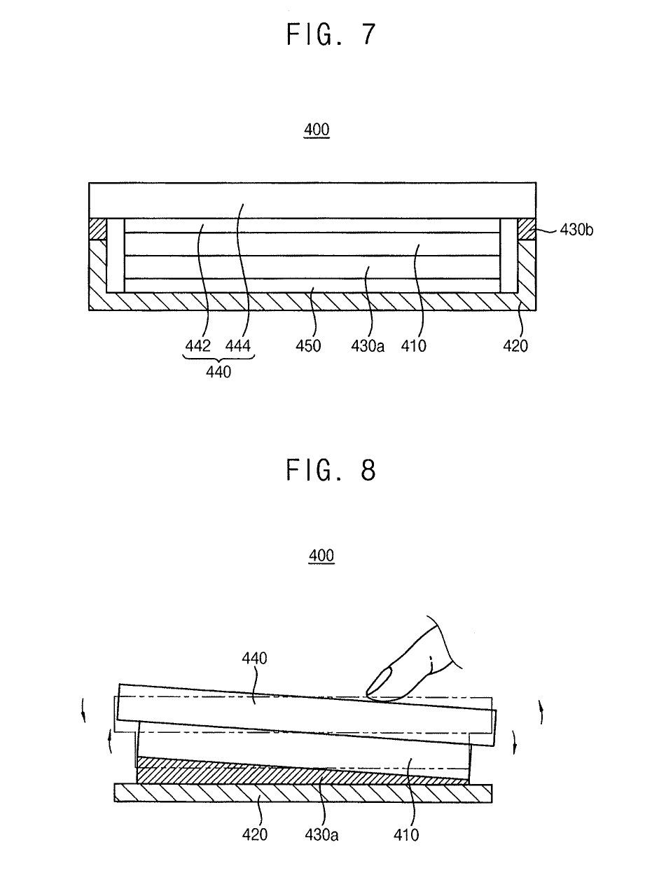

FIG. 7 is a cross-sectional view illustrating a display device 400 in accordance with another example embodiment. FIG. 8 is a diagram illustrating an example in which an external force is applied to the display device 400. The display device 400 is substantially the same as the display device 100 of FIG. 1, and therefore, duplicate descriptions will be omitted.

Referring to FIG. 7, the display device 400 may include a display panel 410, a receiving container 420, a fourth buffer member 430a, a fifth buffer member 430b, a touch panel 440, an adhesive member 450, etc.

The display panel 410 may include a display region and a peripheral region surrounding at least one side of the display region. The display panel 410 may further include a substrate, a display structure disposed on the substrate, and a thin encapsulating member encapsulating the display structure. In example embodiments, the display panel 410 may correspond to a display panel of an organic light emitting diode (OLED) display device. However, embodiments are not limited thereto, e.g., the display panel 410 may correspond to a LCD panel.

The receiving container 420 may include a bottom and a side wall extended substantially perpendicular from the bottom. In example embodiments, the receiving container 420 may receive the display panel 410. For example, the receiving container 420 may include a metal. Examples of the receiving container 420 may include aluminum (Al), stainless steel, etc. In example embodiments, the display panel 410 may be spaced apart from the bottom of the receiving container 420 and the side wall of the receiving container 120.

The display device 400 may include the adhesive member 450. In example embodiments, the adhesive member 450 may attach the receiving container 420 and the display panel 410 received in the receiving container 420 to each other. Here, the adhesive member 450 may include at least one of optical clear adhesive (OCA) and super view resin (SVR). For example, the receiving container 420 may correspond to a bezel in which the display panel 410 is received. In another example, the receiving container 420 may correspond to a mold frame, e.g., the mold frame may be combined with the bezel to fix the display panel 410.

The fourth buffer member 430a may be disposed on at least one of a first surface of the display panel 410 and a second surface of the display panel 410. In example embodiments, the fourth buffer member 430a may include a cushion layer having a predetermined fluidity, e.g., a liquid layer or a gel layer. For example, the cushion layer may be formed on the first surface of the display panel 410. As a result, the display panel 410 and the touch panel 440 may be moved along a direction in which an external force is applied by using the fluidity of the fourth buffer member 430a, i.e., the cushion layer.

In another example, the fourth buffer member 430a may be formed on a second surface of the display panel 410, and the fifth buffer member 430b may be disposed on the side wall of the receiving container 420. In this case, the fourth and the fifth buffer members 430a and 430b may include a material having elasticity, e.g., silicon, a rubber, a urethane, etc. In example embodiments, the fourth and the fifth buffer members 430a and 430b may include substantially the same materials. However, embodiments are not limited thereto, e.g., the fourth and the fifth buffer members 430a and 430b may include different materials.

The touch panel 440 may be disposed on the display region of the display panel 110. In example embodiments, the touch panel 440 may include a polarizing layer disposed on a thin encapsulating member (not illustrated), a touch screen panel 442 disposed on the polarizing layer, a window 444 disposed on the touch screen panel 442, a first adhesive member (not illustrated) interposed between the polarizing layer and the touch screen panel 442, and a second adhesive member (not illustrated) interposed between the touch screen panel 442 and the window 444. For example, the first adhesive member and the second adhesive member may include a resin.

The display device 400 according to example embodiments may include the thin encapsulating member and a structure in which the display panel 410 and the touch panel 440 are integrated, and thus the display device 400 may have a small thickness. However, as a conventional display device may not easily control a foreign substance between the display panel 410 and the receiving container 420, e.g., a user's touch may cause a pooling effect and damage to the thin encapsulating member, the display device 400 according to example embodiments may include a bent display panel 410. That is, the display panel 410 may additionally bend in correspondence with the applied external force, thereby buffer the external force. Hence, the display device 400 may have a small thickness and an improved image quality.

The adhesive member 450 may be disposed in the receiving container 420. For example, the adhesive member 450 may attach the receiving container 420 and the display panel 410 to each other. In another example, the adhesive member 450 may have a porous structure, and thus the display device 400 may prevent a pooling effect when a foreign substance exists between the display panel 410 and the adhesive member 450.

Referring to FIG. 8, when the touch panel 440 receives an external force (e.g., a touch of a user), the display panel 410 and the touch panel 440 may be moved along a direction in which an external force is applied by using the fluidity of a fourth buffer member 430a. That is, as illustrated in FIG. 8, the fluidity of the fourth buffer member 430a may cause the display panel 410 and the touch panel 440 to tilt only at one side. In example embodiments, the fourth buffer member 430a may include a cushion layer formed on the first surface of the display panel 410.

Accordingly, the display device 400 may prevent damage to the display panel 410, e.g., a dark spot, by using the fluidity of the fourth buffer member 530a, and may improve image quality. In addition, the display device 400 may prevent a pooling effect when a foreign substance exists between the display panel 410 and the receiving container 420.

In another example, the display device 400 may further include at least one sixth buffer member (not illustrated) and at least one seventh buffer member (not illustrated). In this case, the sixth buffer member may be disposed on the receiving container 520, may be spaced apart from each other, and may make contact with the peripheral region of the display panel 410, and the seventh buffer member may be disposed on a side wall of the display panel 410.

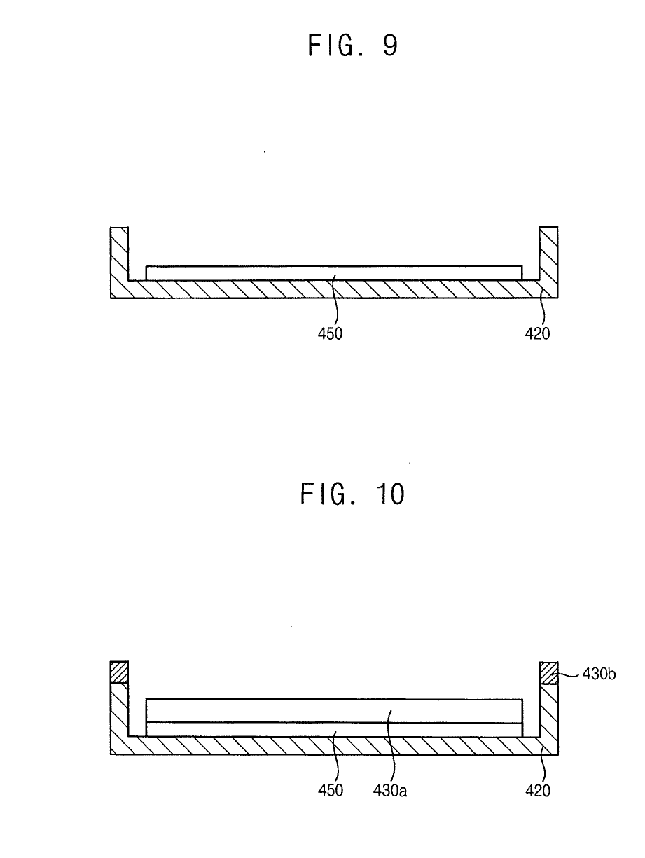

FIGS. 9 through 12 are diagrams illustrating stages in a method of manufacturing a display device in accordance with example embodiments. In FIGS. 9 through 12, the described method is substantially the same as or substantially similar to that in FIGS. 4-6. Further, the stages illustrated in FIGS. 9 through 12 may be employed in other display devices having various configurations where the display panel, the receiving container, the buffer member, the touch panel, etc. may be disposed in various forms.

Referring to FIG. 9, the receiving container 420 may be provided having a bottom and a side wall extended substantially perpendicularly from the bottom. In example embodiments, an adhesive member 450 may be disposed on the bottom of the receiving container 420. In this case, the adhesive member 450 may include at least one of optical clear adhesive (OCA) and super view resin (SVR).

Referring to FIG. 10, at least one fourth buffer member 430a may be disposed on the first surface of the display panel 410, and the fifth buffer member 430b may be disposed on the side wall of the display panel 410. In this case, the fourth buffer member 430a may include a cushion layer that is formed having fluidity (i.e., a liquid type or a gel type). The cushion layer may be formed by a slit coating process, a bar coating process, a spin coating process, etc.

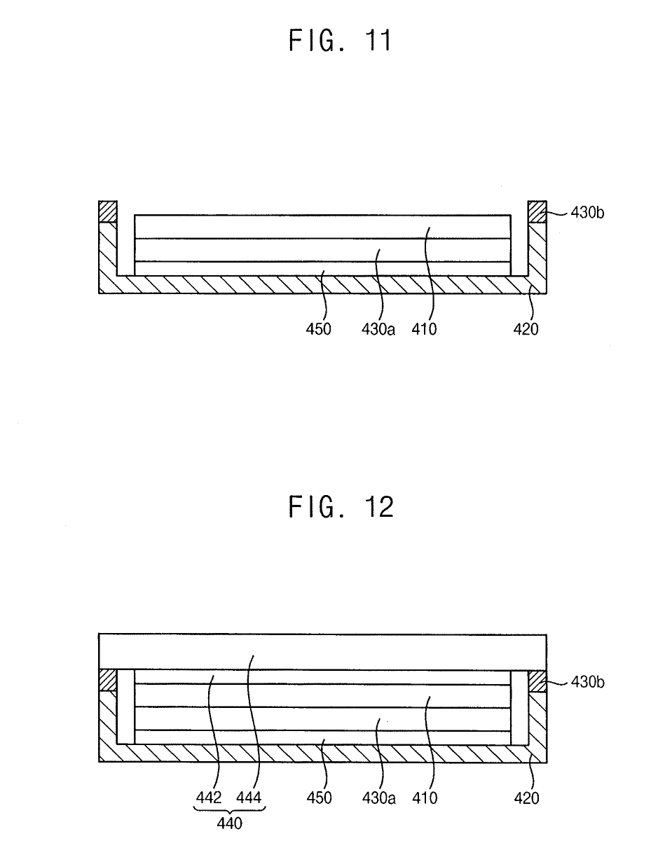

Referring to FIG. 11, the display panel 410 may be disposed on the fourth buffer member 430a. In example embodiments, the display panel 410 may correspond to a display panel of an organic light emitting diode (OLED) display device. However, embodiments are not limited thereto. For example, the display panel 410 may correspond to a display panel of a liquid crystal display (LCD) device.

Referring to FIG. 12, the touch panel 440 may be disposed on the display panel 410. In this case, the touch panel 440 may include the touch screen panel 442 and the window 444. Accordingly, the display panel 410 and the touch panel 440 may be moved along a direction in which an external force is applied by using the fluidity of the fourth buffer member 430a. The display device 400 according to example embodiments may include the thin encapsulating member and a structure in which the display panel 410 and the touch panel 440 are integrated, and thus the display device 400 may have a small thickness and an improved image quality as discussed previously with reference to FIG. 7.

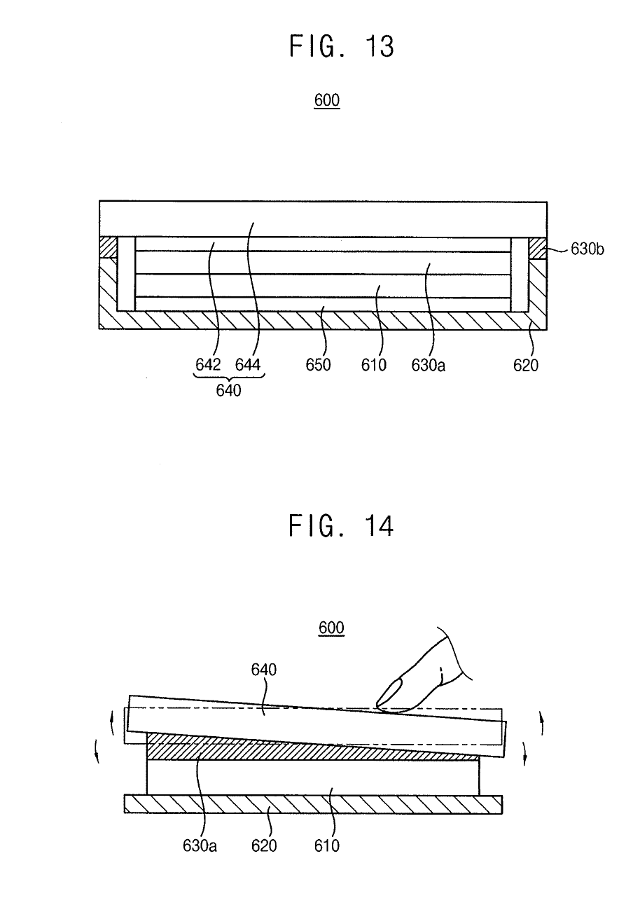

FIG. 13 is a cross-sectional view illustrating a display device in accordance with another example embodiment. FIG. 14 is a diagram illustrating an example in which an external force is applied to a display device of FIG. 13. Detailed descriptions of elements described previously with reference to display devices 100 and 400 will not be repeated.

Referring to FIG. 13, a display device 600 may include a display panel 610, a receiving container 620, a fourth buffer member 630a, a fifth buffer member 630b, a touch panel 660, an adhesive member 650, etc.

In example embodiments, the display panel 610 may correspond to a display panel of an organic light emitting diode (OLED) display device. However, embodiments are not limited thereto. For example, the display panel 610 may correspond to a display panel of a liquid crystal display (LCD) device.

The receiving container 620 may include a bottom and a side wall extended substantially perpendicular from the bottom. In example embodiments, the receiving container 620 may receive the display panel 610. For example, the receiving container 620 may include a metal. Examples of the receiving container 620 may include aluminum (Al), stainless steel, etc. In example embodiments, the display panel 610 may be spaced apart from the bottom of the receiving container 620 and the side wall of the receiving container 120.

The display device 600 may include the adhesive member 650. In example embodiments, the adhesive member 650 may attach the receiving container 620 and the display panel 610 to each other. Here, the adhesive member 650 may include at least one of an optical clear adhesive (OCA) and a super view resin (SVR). For example, the receiving container 620 may correspond to a bezel in which the display panel 610 is received. In another example, the receiving container 620 may correspond to a mold frame, e.g., the mold frame may be combined with the bezel to fix the display panel 610.

In example embodiments, the fourth buffer member 630a may include a coating layer that is formed to have a predetermined fluidity (i.e., a liquid type or a gel type). In this case, the coating layer may be formed on a second surface opposing the first face of the display panel 610. Accordingly, the touch panel 640 may be moved along a direction in which an external force is applied by using the fluidity of the fourth buffer member 630a (i.e., the coating layer).

The fifth buffer member 630b may be disposed on the side wall of the receiving container 620. In this case, the fourth and the fifth buffer members 630a and 630b may include a material having elasticity, e.g., silicon, a rubber, a urethane, etc. In example embodiments, the fourth and the fifth buffer members 630a and 630b may include substantially the same materials. However, embodiments are not limited thereto. For example, the fourth and the fifth buffer members 630a and 630b may include different materials.

The touch panel 660 may be disposed on the display region of the display panel 110. In example embodiments, the touch panel 660 may include a polarizing layer disposed on a thin encapsulating member (not illustrated), a touch screen panel 662 disposed on the polarizing layer, a window 666 disposed on the touch screen panel 662, a first adhesive member (not illustrated) interposed between the polarizing layer and the touch screen panel 662, and a second adhesive member (not illustrated) interposed between touch screen panel 662 and the window 666. For example, the first adhesive member and the second adhesive member may include a resin.

The display device 600 according to example embodiments may include the thin encapsulating member and a structure in which the display panel 610 and the touch panel 640 are integrated, and thus the display device 600 may have a small thickness and an improved image quality, as was discussed previously with reference to the display device 400 of FIG. 7.

The adhesive member 650 may be disposed in the receiving container 620. For example, the adhesive member 650 may attach the receiving container 620 and the display panel 610 to each other. In another example, the adhesive member 650 may have a porous structure, and thus the display device 600 may prevent a pooling effect when a foreign substance exists between the display panel 610 and the adhesive member 650.

Referring to FIG. 14, when an external force, e.g., a touch of a user, is applied to the touch panel 640, the display panel 610 and the touch panel 640 may be moved along a direction in which an external force is applied by using the fluidity of the fourth buffer member 630a. In example embodiments, the fourth buffer member 630a may include a coating layer formed on the first surface of the display panel 610.

Accordingly, the display device 600 may prevent damage to the display panel 610, e.g., a dark spot, by using the fluidity of the fourth buffer member 630a, and may improve image quality. In addition, the display device 600 may prevent a pooling effect when a foreign substance exists between the display panel 610 and the receiving container 620.

Alternatively, the display device 700 may further include at least one sixth buffer member (not illustrated) and at least one seventh buffer member (not illustrated). In this case, the sixth buffer member may be disposed on the receiving container 620, may be spaced apart from each other, and may make contact with the peripheral region of the display panel 610, and the seventh buffer member may be disposed on a side wall of the display panel 610.

By way of summary and review, when the display panel and touch panel are integrated in a conventional display device, the display device cannot control foreign substances between the display panel and a receiving container. Accordingly, when a user touches or presses the touch panel, adjacent liquid crystal molecules may be continuously splashed along the pressurized portion, i.e., a pooling effect, which in turn, may degrade a displayed image quality.

In contrast, according to example embodiments, the display panel may include a peripheral region bent to a back side of the display region. In this case, the display panel may be moved along a direction in which an external force is applied. As a result, a quality of the displayed images of the display device may be improved.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display device, comprising:
a display panel having a display region and a peripheral region bent toward a back side of the display region, the display panel being movable along a direction in which an external force is applied;
a touch panel on the display region of the display panel;
a receiving container having a bottom and a side wall perpendicular to the bottom, the receiving container being configured to receive the display panel;
at least two first buffer member on the bottom of the receiving container and spaced apart from each other, the first buffer members contacting the peripheral region of the display panel; and
at least one second buffer member on the side wall of the receiving container.

2. The device of claim 1, further comprising:
a supporting member disposed in the receiving container, the supporting member supporting the display panel; and
at least one third buffer member interposed between the bottom of the receiving container and the supporting member.

3. The device of claim 2, wherein the first buffer member, the second buffer member, and the third buffer member include same materials.

4. The device of claim 1, wherein the display panel includes:
a display structure on a substrate; and
a thin encapsulating member on the substrate, the thin encapsulating member encapsulating the display structure.

5. The device of claim 4, wherein the touch panel includes:
a polarizing layer disposed on the thin encapsulating member;
a touch screen panel disposed on the polarizing layer;
a window disposed on the touch screen panel;
a first adhesive member interposed between the polarizing layer and the touch screen panel; and
a second adhesive member interposed between touch screen panel and the window.

6. The device of claim 5, wherein the peripheral region of the display panel is configured to additionally bend to the back side of the display region in correspondence with the external force applied to the touch panel.

7. A display device, comprising:
a display panel having a display region and a peripheral region bent toward a back side of the display region, the display panel being movable along a direction in which an external force is applied;
a touch panel on the display region of the display panel;
a receiving container having a bottom and a side wall perpendicular to the bottom, the receiving container being configured to receive the display panel;
a fourth buffer member on at least one of a first surface and a second surface of the display panel; and
at least one fifth buffer member on the side wall of the receiving container.

8. The device of claim 7, further comprising an adhesive member disposed in the receiving container, the adhesive member attaching the receiving container and the display panel to each other.

9. The device of claim 8, wherein the display panel includes:
a display structure disposed on a substrate; and
a thin encapsulating member on the substrate, the thin encapsulating member encapsulating the display structure.

10. The device of claim 9, wherein the touch panel includes:
a polarizing layer disposed on the thin encapsulating member;
a touch screen panel disposed on the polarizing layer;
a window disposed on the touch screen panel;
a first adhesive member interposed between the polarizing layer and the touch screen panel; and
a second adhesive member interposed between touch screen panel and the window.

11. The device of claim 7, wherein the fourth buffer member includes a cushion layer exhibiting fluidity, the display panel and the touch panel being movable along the direction in which the external force is applied via the fluidity of the cushion layer.

12. The device of claim 11, wherein the fourth buffer member includes a coating layer exhibiting fluidity, the display panel and the touch panel being movable along the direction in which the external force is applied via the fluidity of the cushion layer.

13. The device of claim 7, wherein the fourth and fifth buffer members include a same material.

14. The device of claim 7, further comprising an adhesive member disposed in the receiving container, the receiving container and the adhesive member having a porous structure.

15. The device of claim 7, wherein the display panel is received in the receiving container, the display panel being spaced apart from the bottom of the receiving container and the side wall of the receiving container.

16. A method of manufacturing a display device, the method comprising:
providing a receiving container having a bottom and a side wall perpendicular to the bottom;
forming a first buffer member on the bottom of the receiving container;
forming a second buffer member on the side wall of the receiving container;
receiving a display panel in the receiving container, the display panel being movable along a direction in which an external force is applied; and
forming a touch panel on the display panel.

17. The method of claim 16, wherein a peripheral region of the display panel is bent to the back side of the display region in correspondence with an external force applied to the touch panel.

18. A method of manufacturing a display device, the method comprising:
providing a receiving container having a bottom and a side wall perpendicular to the bottom;
receiving a display panel in a receiving container;
forming a fourth buffer member on at least one of a first surface and a second surface of the display panel;
forming a fifth buffer member on the side wall of the receiving container; and
forming a touch panel on the display panel.

19. The method of claim 18, wherein the fourth buffer member and the fifth buffer member are formed of a substantially same material by a slit coating process, a bar coating process, or a spin coating process.

20. The method of claim 19, wherein the fourth buffer member includes a cushion layer exhibiting fluidity, and a coating layer exhibiting fluidity.
